(19) United States
(12) Patent Application Publication
(10) Pub. No.: US 2011/0145775 A1
(43) Pub. Date: Jun. 16, 2011

(54) CELL LIBRARY, LAYOUT METHOD, AND LAYOUT APPARATUS

(75) Inventor: Fumihiko SANO, Yokohama-shi (JP)

(73) Assignee: KABUSHIKI KAISHA TOSHIBA, Tokyo (JP)

(21) Appl. No.: 12/723,554

(22) Filed: Mar. 12, 2010

(30) Foreign Application Priority Data
Dec. 11, 2009 (JP) 2009-281574

(51) Int. Cl. G06F 17/50

(52) U.S. Cl. 716/122; 716/108; 716/118; 716/126

(57) ABSTRACT

In a cell library that is used for layout design of a semiconductor integrated circuit and is a library of design data of cells each realizing a unit function, each of the design data includes attribute information of each edge of a cell associated with an attribute value indicating whether the cell easily causes a defect in a cell adjacently placed across the edge and whether a defect is easily caused by a cell adjacently placed across the edge.

### CROSS-REFERENCE TO RELATED APPLICATIONS

This application is based upon and claims the benefit of priority from the prior Japanese Patent Application No. 2009-281574, filed on Dec. 11, 2009; the entire contents of which are incorporated herein by reference.

### BACKGROUND OF THE INVENTION

1. Field of the Invention

The present invention relates to a cell library, a layout method, and a layout apparatus.

2. Description of the Related Art

Recently, in the field of design of semiconductor integrated circuits, particularly system large scale integrations (LSIs), layout designs are almost routinely made by a method called automatic place and route (P&R). In this method, design data such as a mask pattern are handled in units of primitive cells (such as NAND, NOR, inverters, buffers, composite gates, multiplexers, latches, and registers) each realizing a unit function. Design data of primitive cells are each organized into a library to create a primitive cell library (cell library). Primitive cells for realizing a semiconductor integrated circuit to be designed are taken out of the corresponding cell libraries and automatically placed according to a placement unit defined by a design rule of each process generation, that is, a placement grid. When automatically placed by the P&R method, the primitive cells (hereinafter, simply “cells”) are often placed adjacently to each other with no space therebetween. Therefore, widths and intervals of layers (such as a diffusion layer, a gate terminal layer, a metal wiring layer, an ion implantation layer, and a contact layer) between cells adjacently placed need to satisfy the design rule of each process generation.

When cells are placed adjacently in generations before a generation with a process dimension of 0.1 micrometer, a pattern in a finished shape as almost intended can be formed only by satisfying the design rule of each generation. However, in generations with process dimensions below 0.1 micrometer, lithography problems caused by an optical proximity effect become noticeable and lithography rule check (LRC) is required in addition to design rule check (DRC).

Also in the LRC for generations with process dimensions just below 0.1 micrometer, there are many cases where no problems arise in a lithography process when the LRC for a cell alone is successfully performed. However, when process dimensions of generations approach 50 nanometers, a lithographic error due to a form of an adjacent cell easily occurs particularly in a lowermost metal wiring layer. Therefore, even when one primitive cell is designed, the DRC and the LRC for a cell alone cannot complete verification, and the LRC needs to be performed by placing cells already designed in various placement manners to surround a cell.

When LRC verification is performed for all possible placement manners to achieve verification in consideration of adjacent placement, unrealistic time is required for the verification. According to U.S. Patent Application Publication No. US 2007/0074146, a mask pattern is designed by using a cell library for which optical proximity correction (OPC) at the time of single placement is previously performed. A correction amount of the OPC applied to the cell library is changed in consideration of influences of patterns of cell libraries of cells placed therearound. A group of cells in which placement of surrounding cells including a target cell is the same is then extracted and registered as a cell set. For the same cell sets, the OPC in the cell sets is not recalculated but copied.

According to Japanese Patent Application Laid-Open No. 2004-362420, relations between a target cell and surrounding cells are classified into plural categories. When a relation between the target cell and a surrounding cell falls in a category in which a lithographic error occurs when the target cell is placed at a placement candidate position, a joint cell having a layout structure that enables to be placed adjacent to all cells adjacent to the placement candidate position is placed and then the target cell is placed at the placement candidate position.

According to the two conventional techniques, a portion with a high probability of occurrence of a lithographic error can be extracted more rapidly than in the case where the LRC verification is performed for an entire pattern at a stage after the cells are placed. However, these techniques still include a step of classifying combinations of an extracted target cell and surrounding cells, which needs high calculation costs.

### BRIEF SUMMARY OF THE INVENTION

A cell library according to an embodiment of the present invention is a library of design data of cells each realizing a unit function and is used for layout design of a semiconductor integrated circuit, wherein each of the design data includes attribute information of an edge of a cell associated with an attribute value indicating whether a cell easily causes a defect in a cell adjacently placed across the edge and whether a defect is easily caused by a cell adjacently placed across the edge

A layout method according to an embodiment of the present invention comprises:

roughly placing a plurality of cells based on a cell library that is a library of design data of the cells each realizing a unit function, each of the design data including attribute information of an edge of a cell associated with an attribute value indicating whether a cell easily causes a defect in a cell adjacently placed across the edge and whether a defect is easily caused by a cell adjacently placed across the edge, and based on a net list of the semiconductor integrated circuit to be designed;

first correcting placement positions of the roughly placed cells according to a process generation rule; and

second correcting placement positions based on the attribute information when there is a risk boundary where a defect is caused at a cell boundary between adjacent cells after the first correcting, to eliminate the risk boundary.

A layout apparatus according to an embodiment of the present invention comprises:

a roughly placing unit that roughly places a plurality of cells based on a cell library that is a library of design data of the cells each realizing a unit function, each of the design data including attribute information of an edge of a cell associated with an attribute value indicating whether the cell easily causes a defect in a cell adjacently placed across the edge and whether a defect is easily caused by a cell adjacently placed across the edge, and based on a net list of the semiconductor integrated circuit to be designed;

a first position correcting unit that corrects placement positions of the roughly placed cells according to a process generation rule; and

a second position correcting unit that corrects placement positions based on the attribute information when there is a risk boundary where a defect is caused at a cell boundary between adjacent cells after correction by the first position correcting unit, to eliminate the risk boundary.

### BRIEF DESCRIPTION OF THE DRAWINGS

FIG. 1 is a schematic diagram for explaining an example of a layout of cells;

FIG. 2 is a schematic diagram for explaining combinations of adjacent placement risk attributes at a cell boundary;

FIG. 3 is an example of an external-form/terminal-position information library having adjacent placement risk attributes noted therein;

FIG. 4 is an example of a timing library having adjacent placement risk attributes noted therein;

FIG. 5 is a schematic diagram for explaining a configuration of a layout apparatus according to a first embodiment of the present invention;

FIG. 6 is a schematic diagram for explaining a hardware configuration of the layout apparatus according to the first embodiment;

FIG. 7 is a flowchart for explaining a layout method according to the first embodiment;

FIG. 8 is a schematic diagram for explaining an order of setting of a target cell;

FIG. 9 is a flowchart for explaining a risk-boundary eliminating process according to the first embodiment;

FIG. 10 is a schematic diagram for explaining a configuration of a layout apparatus according to a second embodiment of the present invention;

FIG. 11 is a flowchart for explaining a layout method according to the second embodiment;

FIG. 12 is a schematic diagram for explaining a concept of a risk-boundary eliminating process according to a third embodiment of the present invention;

FIG. 13 is a schematic diagram for explaining a configuration of a layout apparatus according to the third embodiment;

FIG. 14 is a flowchart for explaining the risk-boundary eliminating process according to the third embodiment;

FIG. 15 is a schematic diagram for explaining a concept of a risk-boundary eliminating process according to a fourth embodiment of the present invention;

FIG. 16 is a schematic diagram for explaining a configuration of a layout apparatus according to the fourth embodiment; and

FIG. 17 is a flowchart for explaining the risk-boundary eliminating process according to the fourth embodiment.

### DETAILED DESCRIPTION OF THE INVENTION

Exemplary embodiments of a cell library, a layout method, and a layout apparatus according to the present invention will be explained below in detail with reference to the accompanying drawings. The present invention is not limited to the following embodiments.

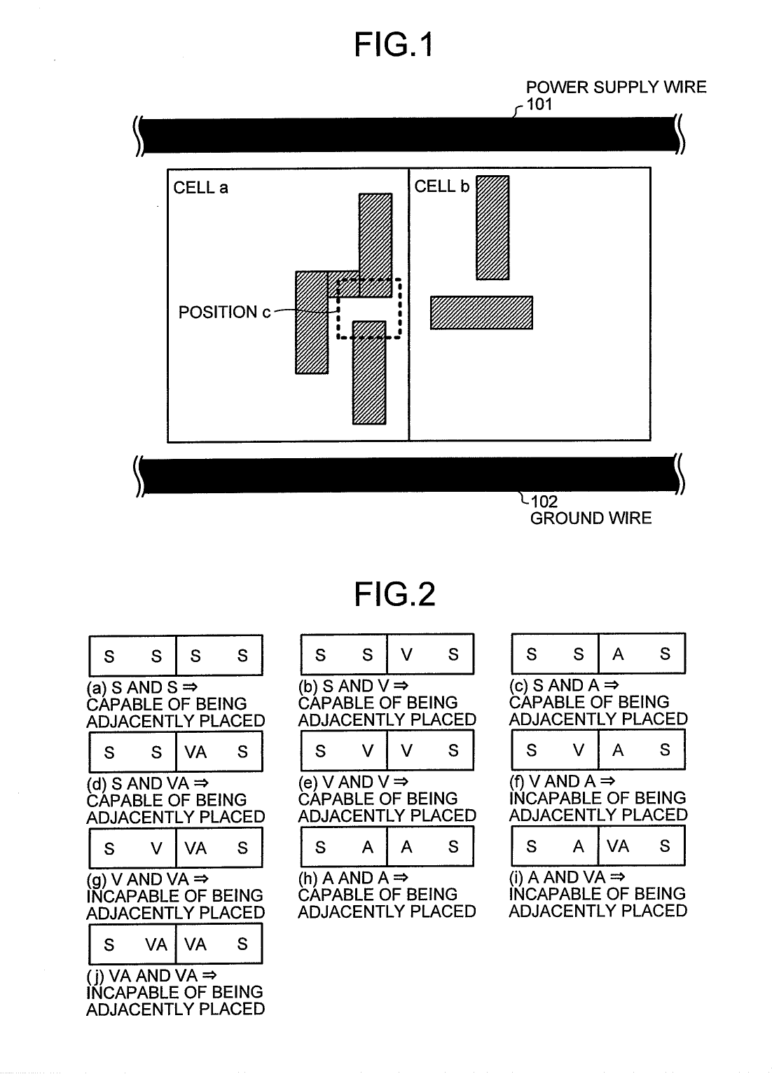

A cell library according to a first embodiment of the present invention is explained with reference to FIGS. 1 to 4.

Power supply wires and ground wires are alternately placed in parallel to each other on a semiconductor substrate (wafer). Each primitive cell (hereinafter, simply “cell”) is placed between the power supply wire and the ground wire. Each cell is supplied with power from the power supply wire and grounded to the ground wire. FIG. 1 is an example of a layout of cells. A power supply wire 101 is placed in a lateral direction at an upper portion in FIG. 1, and a ground wire 102 parallel to the power supply wire 101 is placed at a lower portion in FIG. 1. Two cells “a” and “b” are placed adjacent to each other between the power supply wire 101 and the ground wire 102.

It is defined hereinafter that a direction of placement of the ground wire and the power supply wire is a longitudinal direction (from top to bottom) and the direction of the ground wire (the direction of the power supply wire) is lateral (from left to right) to represent positional relations (top, bottom, left, and right), like in the example shown in FIG. 1.

Each of mask patterns of the cells “a” and “b” alone has passed the DRC verification and the LRC verification and is organized into a library to form a part of a cell library. For easier comprehension, the cells “a” and “b” shown in FIG. 1 are drawn in design patterns, instead of mask patterns.

It is shown that the cell “a” has a tendency to cause a defect at a position “c” in FIG. 1, which is at a distance reached by an optical proximity effect of the cell “b” adjacently placed. It is also shown that the cell “b” causes no defect even when it is adjacently placed on the right side of the cell “a”. That is, while the cells “a” and “b” each hardly cause a defect such as short-circuiting and breaking (lithographic error) alone, the cell “a” easily causes a defect at the position “c” when the cell “b” is adjacently placed on the right side of the cell “a”. A portion where a defect is easily caused is referred to as “risk portion”.

When the LRC verification is performed to a layout chart after placement, a risk portion produced by adjacent placement like the cells “a” and “b” can be detected. However, the LRC verification to the entire layout chart requires great time. In the first embodiment, the cell library includes attribute information having an attribute (an adjacent placement risk attribute) value of each cell, indicating whether a defect is easily generated in a target cell due to an adjacent cell (whether a target cell is easily affected by the adjacent cell) and whether the target cell easily generates a defect due to an adjacent cell (whether the target cell easily affects the adjacent cell) described therein. In this way, a boundary between cells placed in such a combination that generates a risk portion (a risk boundary) can be easily detected during layout.

Following four types of the adjacent placement risk attributes are defined, for example. That is,
(1) “S (Safe)” attribute indicating that a cell is hardly affected by an adjacent cell and hardly affects the adjacent cell.
(2) “V (Victim)” attribute indicating that a cell is easily affected by an adjacent cell but hardly affects the adjacent cell.
(3) “A (Aggressor)” attribute indicating that a cell is hardly affected by an adjacent cell but easily affects the adjacent cell.
(4) “VA (Victim and Aggressor)” attribute indicating that a cell is easily affected by an adjacent cell and easily affects the adjacent cell.

The adjacent placement risk attribute is provided to left and right edges of each cell, respectively. The adjacent placement risk attribute can be also provided to top and bottom edges of each cell, respectively. The cells are normally placed to share the ground wire and the power supply wire with upper and lower cells. Accordingly, when the ground wire and the power supply wire are made thicker, boundaries at which a defect is easily generated between the top and bottom edges are reduced. Only the adjacent placement risk attributes of the left and right edges are considered here.

Each cell includes a plurality of layers (such as a diffusion layer, a gate electrode layer, and a metal wiring layer). The adjacent placement risk attribute is assigned to each layer. Because the metal wiring layers have complicated and various shapes, it is assumed that the adjacent placement risk attributes of the metal wiring layer greatly vary with cells.

The adjacent placement risk attribute can be determined as follows. A target cell and other cells are placed adjacently, and the LRC verification is performed therefor to observe portions at which “warning” indicating a risk portion is reported. The adjacent placement risk attribute is determined based on the portions at which warning is reported. In the LRC verification, warning is reported at portions that are determined to have higher probabilities of defects in a lithography process than a predetermined level.

More specifically, the attribute “S” is assigned to an edge of a target cell facing a cell boundary when warning is hardly issued at a position reached by an optical proximity effect from a target cell side of the cell boundary and warning is hardly issued at a position reached by an optical proximity effect from an adjacent cell side of the cell boundary. Whether warning is hardly issued or easily issued at a position can be determined based on whether a probability of occurrence of warning, which is observed by performing the LRC verification while changing an adjacent cell, is lower or higher than a predetermined threshold, for example.

Conditions of assignment of the attribute “V” are different from those of the attribute “S” in that the attribute “V” is assigned when warning is easily issued at a position reached by an optical proximity effect from a target cell side of a cell boundary. Conditions of assignment of the attribute “A” is different from those of the attribute “S” in that the attribute “A” is assigned when warning is easily issued at a position reached by an optical proximity effect from an adjacent cell side of a cell boundary. The attribute “VA” is assigned to an edge of a target cell when warning is easily issued at a position reached by an optical proximity effect from a target cell side of a cell boundary and warning is easily issued at a position reached by an optical proximity effect from an adjacent cell side of the cell boundary.

FIG. 2 depicts combinations of adjacent placement risk attributes at cell boundaries. As shown in FIG. 2, there are ten possible adjacency combinations: (a) the attributes S and S, (b) the attributes S and V, (c) the attributes S and A, (d) the attributes S and VA, (e) the attributes V and V, (f) the attributes V and A, (g) the attributes V and VA, (h) the attributes A and A, (i) the attributes A and VA, and (j) the attributes VA and VA.

A probability of a risk boundary is high particularly in combinations including an edge having the attribute VA that easily affects an adjacent cell assigned thereto. Therefore, when adjacency of cells in the combinations (f), (g), (i), and (j) among the combinations shown in FIG. 2 is inhibited during layout, a layout chart that hardly causes defects can be obtained.

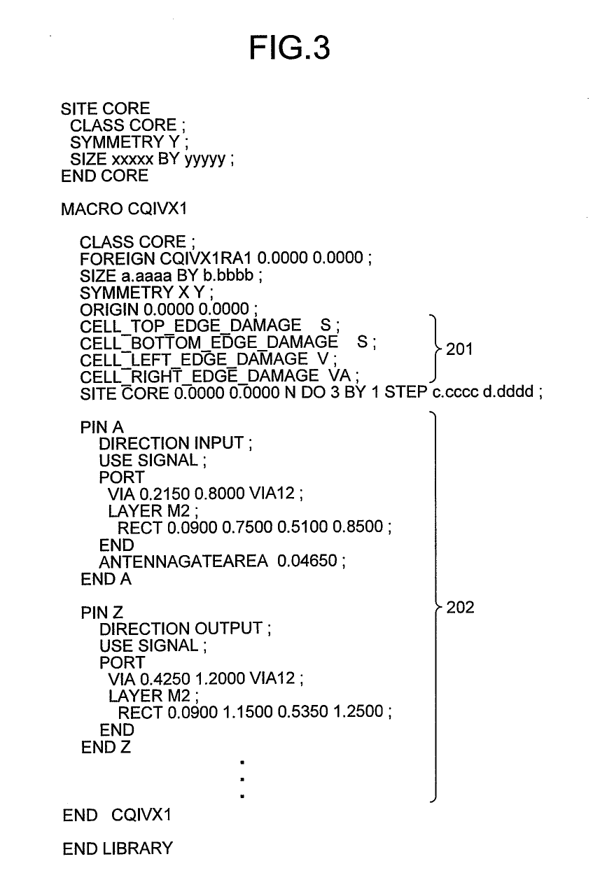

The attribute information can be noted in the design data included in the cell library if the adjacent placement risk attribute of each cell can be retrieved therefrom. For example, the attribute information can be noted in an external-form/terminal-position information library, which is a library of external-form/terminal-position information describing an external form and a terminal position of each cell as one kind of the design data. FIG. 3 is an example of an external-form/terminal-position information library having adjacent placement risk attributes noted therein. As shown in FIG. 3, following four lines of descriptions indicating attribute values of top, bottom, left, and right edges of a cell named “CQIVX1” are inserted into a field for defining a size of the cell and the like (reference numeral 201 in FIG. 3).

CELL TOP EDGE DAMAGE S;

CELL BOTTOM EDGE DAMAGE S:

CELL LEFT EDGE DAMAGE V;

CELL RIGHT EDGE DAMAGE VA;

This indicates that the attribute values of the top, bottom, left, and right edges of the cell “CQIVX1” are S, S, V, and VA, respectively. Terminal position information of pins A, Z, and the like included in the cell “CQIVX1” is listed below (reference numeral 202 in FIG. 3). While the attribute value associated with one layer is described in this example, an attribute value of each layer can be described.

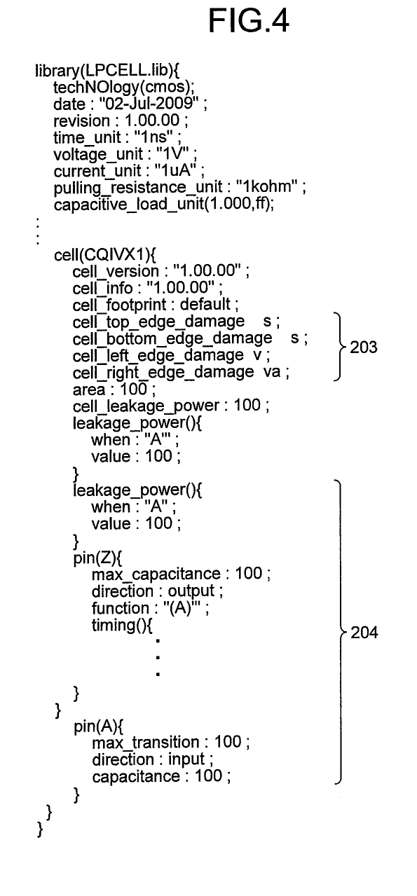

In another example of descriptions of adjacent placement risk attributes, the adjacent placement risk attributes can be noted in a timing library, which is a library of timing information, such as input transition time, output transition time, and delay time, as one kind of the design data. FIG. 4 is an example of a timing library having adjacent placement risk attributes noted therein. As shown in FIG. 4, followings (reference numeral 203 in FIG. 4) are described in a field before descriptions of various kinds of timing information related to the cell “CQIVX1” (reference numeral 204 in FIG. 4):

cell_top_edge_damage s;

cell_bottom_edge_damage s;

cell_left_edge_damage v;

cell_right_edge_damage va;

This indicates that the attribute values of the top, bottom, left, and right edges of the cell “CQIVX1” are S, S, V, and VA, respectively. While the attribute value associated with one layer is also described like in the example of the external-form/terminal-position information library, an attribute value of each layer can be described.

A layout method using the cell library according to the first embodiment is explained. In the layout method according to the first embodiment, the risk boundaries in the combinations (f), (g), (i), and (j) shown in FIG. 2 are detected, and a gap is inserted into the detected risk boundaries to prevent adjacency of two edges constituting the risk boundaries.

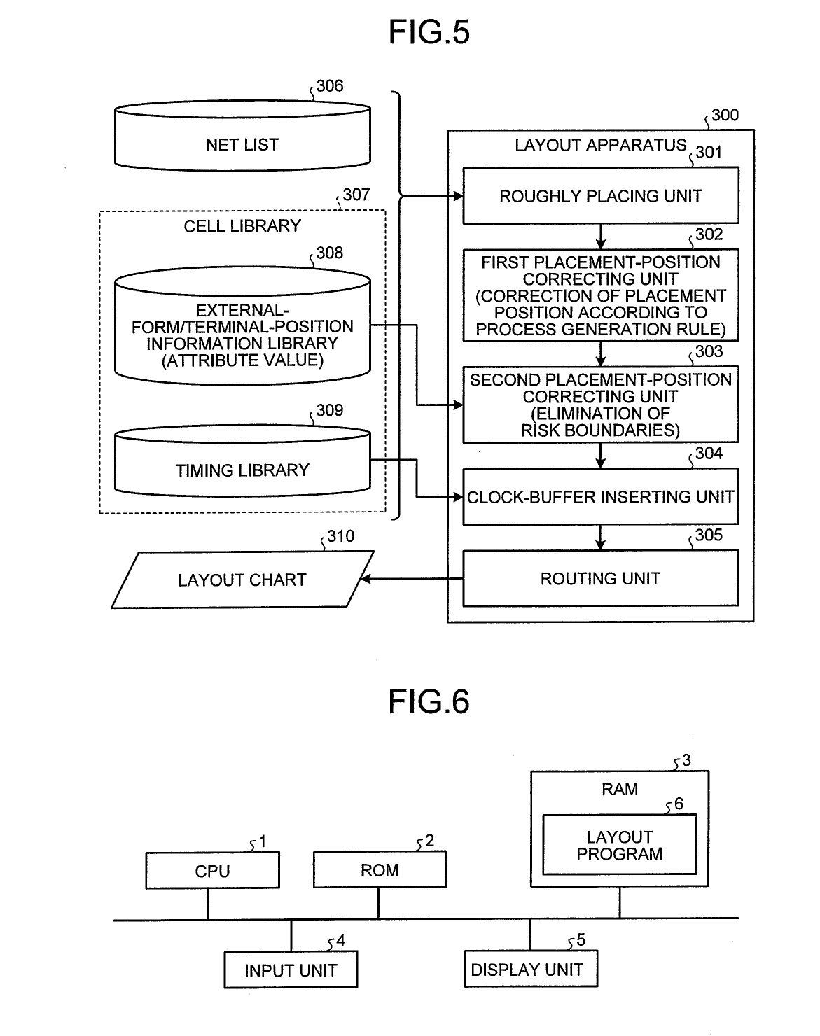

FIG. 5 is a configuration diagram of a layout apparatus that automatically performs the layout method. It is assumed here that adjacent placement risk attributes are noted in an external-form/terminal-position information library. A net list 306 generated by logical synthesis, and a cell library 307 including an external-form/terminal-position information library 308 having the adjacent placement risk attributes noted therein and a timing library 309 are inputted to a layout apparatus 300, and a layout chart 310 describing a mask pattern layout in a format such as GDS is outputted therefrom.

The layout apparatus 300 includes a roughly placing unit 301 that roughly places cells based on the net list 306 and the cell library 307, a first placement-position correcting unit 302 that corrects a layout of the cells placed by the roughly placing unit 301 according to a process generation rule, a second placement-position correcting unit 303 that eliminates risk boundaries from a layout corrected by the first placement-position correcting unit 302 based on the adjacent placement risk attributes noted in the external-form/terminal-position information library 308, a clock-buffer inserting unit 304 that inserts a clock buffer into a layout having the placement position corrected by the second placement-position correcting unit 303 based on the timing library 309, and a routing unit 305 that performs routing for a layout having the clock buffer inserted by the clock-buffer inserting unit 304 to complete the layout chart 310.

FIG. 6 is a hardware configuration of the layout apparatus 300. The layout apparatus 300 has a computer configuration including a central processing unit (CPU) 1, a read only memory (ROM) 2, a random access memory (RAM) 3, an input unit 4, and a display unit 5. These components are connected through a bus line.

The CPU 1 executes a layout program 6 which is a computer program product for realizing the layout method according to the first embodiment. The display unit 5 is a liquid crystal monitor or the like, and displays output information to a user on an operation screen based on an instruction from the CPU 1. The input unit 4 includes a mouse and a keyboard, and receives an operation of the layout apparatus 300 instructed by the user. Operation information inputted by the input unit 4 is sent to the CPU 1.

The layout program 6 is stored in the ROM 2 and loaded into the RAM 3 through the bus line. FIG. 6 depicts a state where the layout program 6 is loaded into the RAM 3. The CPU 1 reads the layout program 6 from the ROM 2 according to input of the instruction through the input unit 4 by the user, and expands the layout program 6 in a program storage area in the RAM 3 to perform various processes. The net list 306 and the cell library 307 are inputted from an external storage device or the like. The CPU 1 performs the various processes based on the net list 306 and the cell library 307 inputted from the external storage device or the like. Intermediate data generated during the various processes are temporarily stored in a data storage area formed in the RAM 3. The CPU 1 outputs the created layout chart 310 to the program storage area of the RAM 3, the external storage device, or the like. The layout program 6 can be stored in a storage device such as a disk, or provided or distributed by being downloaded through a network such as the Internet. The layout program 6 can be previously incorporated in the ROM 2 or the like.

The layout program 6 has a module configuration including the roughly placing unit 301, the first placement-position correcting unit 302, the second placement-position correcting unit 303, the clock-buffer inserting unit 304, and the routing unit 305. The layout program 6 is loaded into the RAM 3 so that these units are generated in the RAM 3.

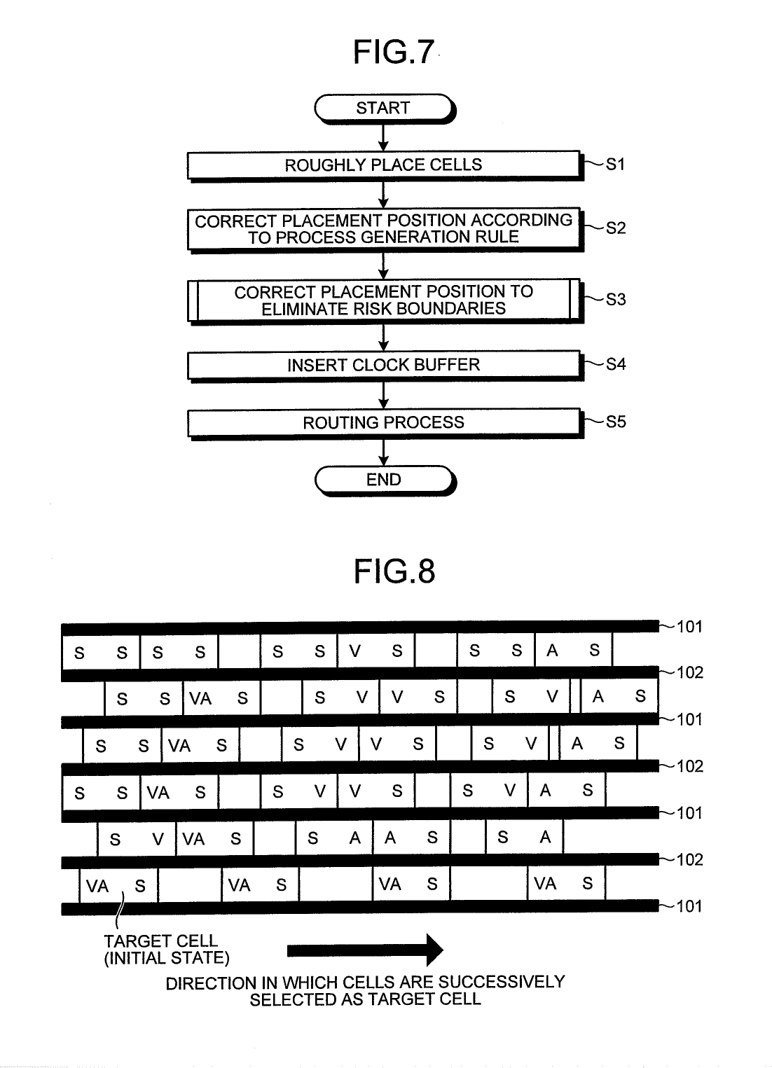

The layout method performed by using the layout apparatus 300 is explained. FIG. 7 is a flowchart for explaining the layout method. The roughly placing unit 301 roughly places cells described in the net list 306 based on the net list 306 and the cell library 307 (S1). Specifically, the roughly placing unit 301 obtains form and terminal position information of each cell described in the net list 306 from the external-form/terminal-position information library 308, and obtains timing information of each cell such as transition time from the timing library 309. The roughly placing unit 301 then roughly places the cells to satisfy connection relations between cells described in the net list 306 and timing constraints previously determined, based on the obtained form and terminal position information and timing information.

The first placement-position correcting unit 302 corrects rough placement positions of the cells according to a process generation rule (S2). At Step S2, the first placement-position correcting unit 302 performs a process of correcting the cells roughly placed to have a placement according to a placement interval (placement grid, or simply grid) corresponding to a design rule of the process generation. The placement according to the placement grid indicates that cells are placed in such a manner that one corner of each cell coincides with an intersection of the grid, for example. Also at Step S2, the first placement-position correcting unit 302 corrects the placement positions to eliminate overlapping of cells.

The second placement-position correcting unit 303 detects risk boundaries from a layout corrected by the first placement-position correcting unit 302, and corrects the placement positions of the cells in the layout to eliminate the detected risk boundaries (S3). Specifically, the second placement-position correcting unit 303 selects one target cell, and determines whether a combination of attribute values of respective edges at a boundary between the target cell and an adjacent cell is a combination of edges capable of being adjacently placed or a combination of edges incapable of being adjacently placed. In the case of the combination of edges incapable of being adjacently placed, a gap corresponding to one grid is inserted between the target cell and the adjacent cell to reposition the adjacent cell. A distance of one grid is normally longer than a distance affected by the optical proximity effect. Accordingly, when a gap corresponding to one grid is provided at a cell boundary as a risk boundary, warning is not issued in the LRC verification. That is, the risk boundary is eliminated.

This process is referred to as a risk-boundary eliminating process. A condition where a combination of edges corresponds to any one of the combinations (f), (g), (i), and (j) shown in FIG. 2 as the combinations of edges incapable of being adjacently placed is referred to as a placement position correction condition.

The second placement-position correcting unit 303 performs the risk-boundary eliminating process by successively selecting one of the cells in the layout chart as the target cell, to eliminate risk boundaries from all the cells. When cells are laid out as shown in FIG. 8, a cell in the bottom-left corner of FIG. 8 is selected as a target cell in an initial state and then a cell on the right thereof is successively selected as a target cell, as an example of a selecting method for the target cell. When there are no more cells on the right, a cell placed on a leftmost position in a line immediately above is selected as a target cell. In this way, the process is successively performed for all the cells.

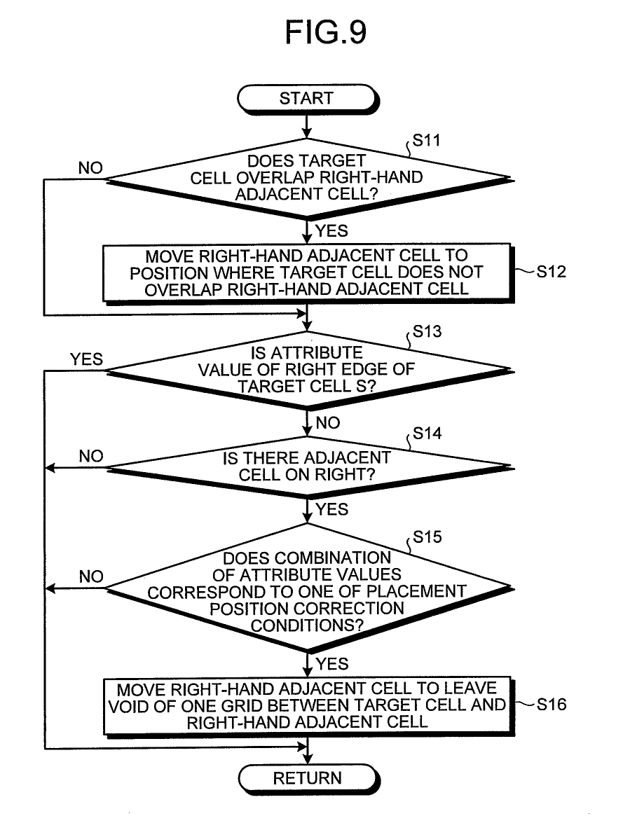

FIG. 9 is a flowchart for explaining the risk-boundary eliminating process. The second placement-position correcting unit 303 determines whether the target cell overlaps an adjacent cell on the right hand (hereinafter, simply “right-hand adjacent cell”) (S11). When the target cell overlaps the right-hand adjacent cell (YES at Step S11), the second placement-position correcting unit 303 moves the right-hand adjacent cell to a position where the target cell does not overlap the adjacent cell (S12). When the target cell does not overlap the right-hand adjacent cell (NO at Step S11), the process at S12 is skipped. When there is no adjacent cell on the right hand, the process at S12 is similarly skipped.

The second placement-position correcting unit 303 then determines whether an attribute value of a right edge of the target cell is S (S13). When the attribute value of the right edge of the target cell is S (YES at Step S13), the risk-boundary eliminating process for the target cell is brought to RETURN.

When the attribute value of the right edge of the target cell is not S (NO at Step S13), the second placement-position correcting unit 303 determines whether there is a right-hand adjacent cell (S14). When there is no right-hand adjacent cell (NO at Step S14), the risk-boundary eliminating process for the target cell is brought to RETURN.

When there is a right-hand adjacent cell (YES at Step S14), the second placement-position correcting unit 303 determines whether a combination of the attribute value of the right edge of the target cell and an attribute value of a left edge of the right-hand adjacent cell meets the placement position correction conditions (S15). When the combination does not meet the placement position correction conditions (NO at Step S15), the risk-boundary eliminating process for the target cell is brought to RETURN.

When the combination meets the placement position correction conditions (YES at Step S15), the second placement-position correcting unit 303 moves the right-hand adjacent cell to the right by a distance corresponding to one grid (S16), and then the risk-boundary eliminating process for the target cell is brought to RETURN. The second placement-position correcting unit 303 performs the risk-boundary eliminating process for all layers in the target cell and then performs the risk-boundary eliminating process for another cell selected as a target cell.

After the process at Step S3, the clock-buffer inserting unit 304 refers to the timing library 309 and inserts a clock buffer to the layout from which the risk boundaries are eliminated (S4). The routing unit 305 performs routing for the layout having the clock buffer inserted therein (S5), thereby completing the layout chart 310.

In the above explanations, “S”, “V”, “A”, and “VA” are defined as the adjacent placement risk attributes. However, the adjacent placement risk attributes can include more kinds of attribute values. Expressions of the adjacent placement risk attributes are not limited to the above. For example, “S”, “V”, “A”, and “VA” can be expressed by values of “00”, “01”, “10”, and “11”, respectively. The process at Step S14 and the process at Step S11 or S13 can be interchanged.

While the second placement-position correcting unit 303 moves the right-hand adjacent cell to the right by a distance of one grid to eliminate the risk boundary, the second placement-position correcting unit 303 can move the right-hand adjacent cell by a distance of two or more grids. In the future, further downsizing may be achieved and accordingly the optical proximity effect may reach a distance of several grids. In such cases, the second placement-position correcting unit 303 sets the number of grids by which the adjacent cell is moved so that the distance of movement exceeds a distance reached by the optical proximity effect. Alternatively, the second placement-position correcting unit 303 can move the adjacent cell by a desired number of grids according to a combination of attribute values of edges constituting a cell boundary.

As described above, in the first embodiment, the design data of each cell is adapted to include the attribute information of edges of the cell associated with attribute values indicating whether a defect is easily generated between the cell and an adjacent cell. Based on the attribute information, correction can be performed by a simple process. In this way, the layout chart having risk boundaries between cells eliminated therefrom can be obtained.

Plural cells are roughly placed based on the cell library of the design data including the attribute information of each cell, which is association of edges of a cell and attribute values thereof indicating whether the cell easily causes a defect in a cell adjacently placed across the edge and whether a defect is easily caused by a cell adjacently placed across the edge, and the net list of a semiconductor integrated circuit to be designed. Placement positions of the cells roughly placed are corrected based on a placement grid prepared according to a process generation rule. After the first correction, when there is a risk boundary constituted by an edge associated with an attribute value indicating that a cell easily causes a defect in an adjacent cell and an edge associated with an attribute value indicating that a defect is easily caused by an adjacent cell, placement positions of these two cells constituting the risk boundary are corrected to prevent adjacent placement of the two edges. Therefore, the step of extracting combinations of a target cell and surrounding cells and classifying the extracted combinations, which is needed in the conventional technique and requires high calculation costs, is not needed. Therefore, a layout chart that hardly causes a defect can be created by a simple process. Further, the simple process of inserting a gap between the cells constituting the risk boundary to prevent direct adjacency of the cells enables to eliminate the risk boundary.

Insertion of a clock buffer at a cell boundary as the risk boundary sometimes causes the cell boundary to be no longer the risk boundary. In such cases, when a gap is inserted at the cell boundary, a useless space corresponding to the inserted gap is produced. Therefore, in a second embodiment of the present invention, risk boundaries are eliminated from a layout having a clock buffer inserted therein.

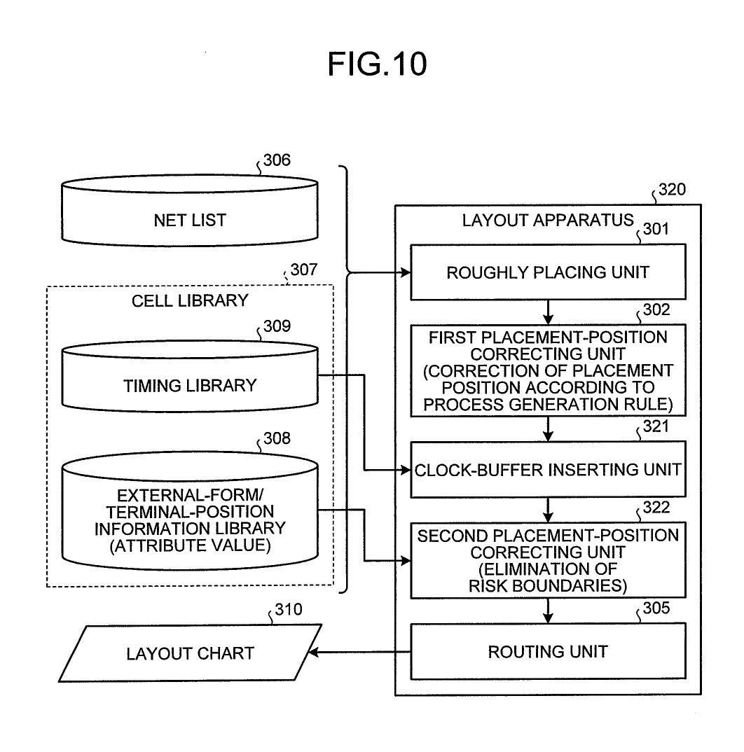

FIG. 10 is a configuration diagram of a layout apparatus according to the second embodiment. Constituent units having like functions as those in the first embodiment are denoted by like reference numerals as those in the first embodiment and detailed explanations thereof will be omitted.

A layout apparatus 320 includes the roughly placing unit 301, the first placement-position correcting unit 302, a clock-buffer inserting unit 321, a second placement-position correcting unit 322, and the routing unit 305. The clock-buffer inserting unit 321 is provided as a constituent unit different from that in the first embodiment. The clock-buffer inserting unit 321 refers to the timing library 309 and inserts a clock buffer to a layout of cells corrected by the first placement-position correcting unit 302. The second placement-position correcting unit 322 corrects a layout having the clock buffer inserted therein by the clock-buffer inserting unit 321 based on the adjacent placement risk attributes noted in the external-form/terminal-position information library 308 to eliminate risk boundaries from the layout. The routing unit 305 performs routing for the layout from which the risk boundaries are eliminated by the second placement-position correcting unit 322 to create the layout chart 310.

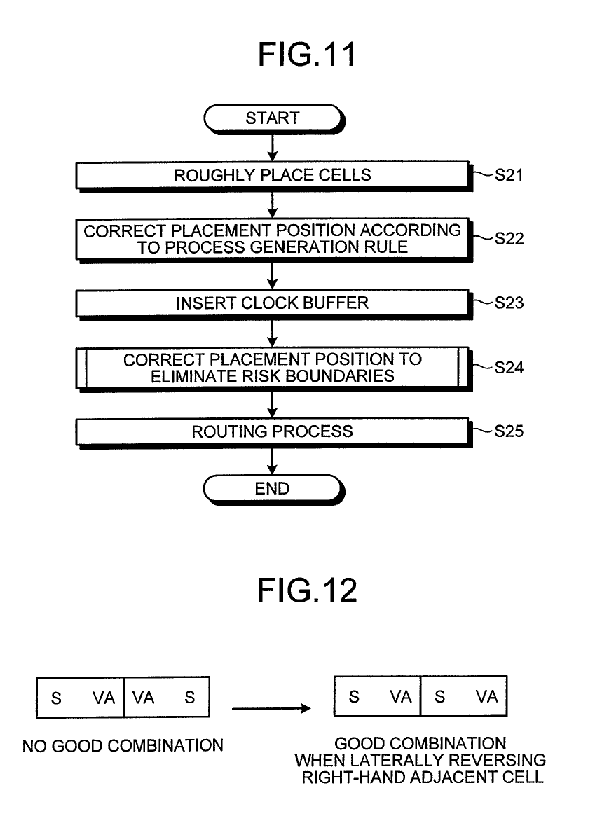

FIG. 11 is a flowchart for explaining a layout method according to the second embodiment. The same operations as those at Steps S1 and S2 are first performed at Steps S21 and S22, respectively. The clock-buffer inserting unit 321 inserts a clock buffer to a layout subjected to placement position correction at Step S22 (S23). The second placement-position correcting unit 322 successively performs the same risk-boundary eliminating process as that in the first embodiment to each cell in a layout having the clock buffer inserted therein at Step S23, thereby eliminating the risk boundaries (S24). The routing unit 305 performs routing for a layout from which the risk boundaries are eliminated (S25), so that the layout chart 310 is completed.

As described above, according to the second embodiment, the risk boundaries are eliminated after the clock buffer is inserted between cells. Because the clock buffer can easily change attribute values of right and left edges of a cell to S, cells having attribute values of V, A, or VA can be placed adjacent thereto. That is, occasions where a gap is inserted between cells constituting a risk boundary eventually come to be fewer than in the first embodiment. This can reduce a placement area as compared to the first embodiment.

In a third embodiment of the present invention, a risk boundary is eliminated by laterally reversing one of cells constituting the risk boundary. FIG. 12 is a conceptual diagram of a risk-boundary eliminating process according to the third embodiment. A right edge of a target cell having a left edge with the attribute S and the right edge with the attribute VA, and a left edge of a right-hand adjacent cell having the left edge with the attribute VA and a right edge with the attribute S are adjacently placed and constitute a risk boundary. When the right-hand adjacent cell is laterally reversed, the left edge of the right-hand adjacent cell has the attribute S, and accordingly the cell boundary comes to be no longer a risk boundary.

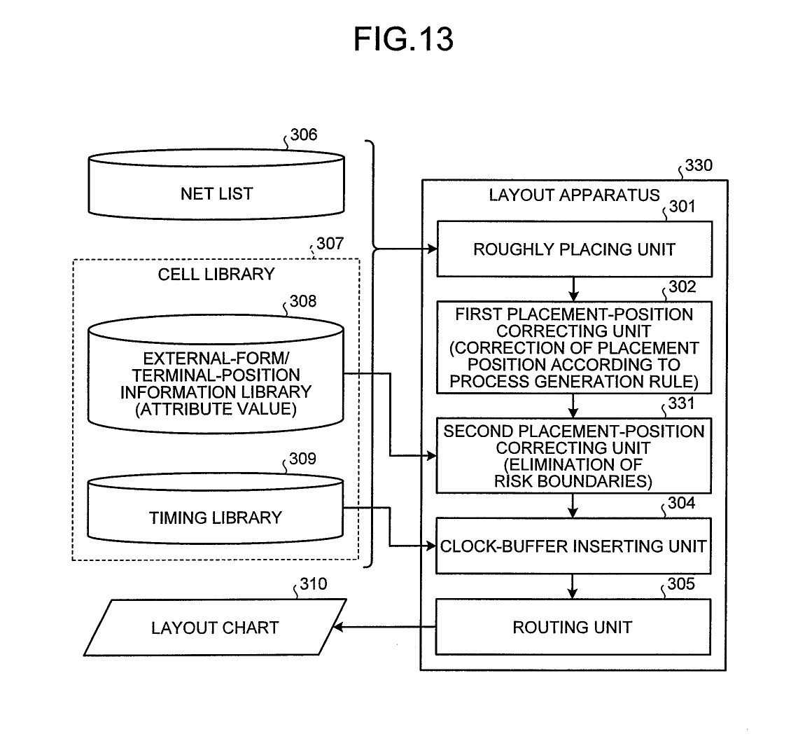

FIG. 13 is a configuration diagram of a layout apparatus according to the third embodiment. Constituent units having like functions as those in the first embodiment are denoted by like reference numerals as those in the first embodiment and detailed explanations thereof will be omitted. A layout apparatus 330 includes a second placement-position correcting unit 331 as a different constituent unit from that in the first embodiment. The second placement-position correcting unit 331 performs the risk-boundary eliminating process according to the third embodiment for a layout corrected by the first placement-position correcting unit 302, thereby eliminating a risk boundary.

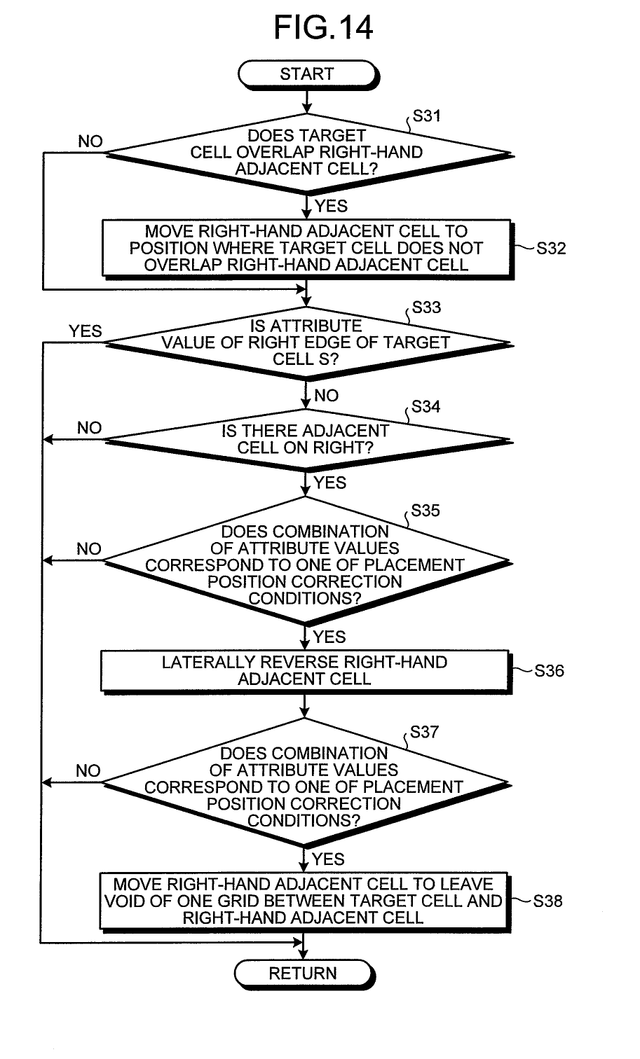

A layout method according to the third embodiment is explained. Only the risk-boundary eliminating process as a different part from the first embodiment is explained here. FIG. 14 is a flowchart for explaining the risk-boundary eliminating process according to the third embodiment.

At Steps S31 to S34 in FIG. 14, the second placement-position correcting unit 331 performs the same processes as those at Steps S11 to S14 performed by the second placement-position correcting unit 303. The second placement-position correcting unit 331 then determines whether a combination of an attribute value of a right edge of a target cell and an attribute value of a left edge of a right-hand adjacent cell meets the placement position correction conditions (S35). When the placement position correction conditions are not met (NO at Step S35), the risk-boundary eliminating process for the target cell is brought to RETURN.

When the placement position correction conditions are met (YES at Step S35), the second placement-position correcting unit 331 laterally reveres the right-hand adjacent cell (S36), and determines again whether a combination of the attribute value of the right edge of the target cell and an attribute value of a left edge of the right-hand adjacent cell meets the placement position correction conditions (S37). When the placement position correction conditions are not met (No at Step S37), the risk-boundary eliminating process for the target cell is brought to RETURN. That is, this implies that the risk boundary is eliminated by the reverse of the right-hand adjacent cell at S36.

When the placement position correction conditions are met (YES at Step S37), the second placement-position correcting unit 331 moves the right-hand adjacent cell to the right by a distance of one grid (S38), and then the risk-boundary eliminating process for the target cell is brought to RETURN.

As described above, according to the third embodiment, a risk boundary can be eliminated by a simple process of reversing one of cells constituting the risk boundary. Frequencies at which a gap is inserted are reduced, and accordingly a placement area can be reduced as compared to the first embodiment.

In the above explanations, the risk-boundary eliminating process is performed before insertion of a clock buffer. However, the risk-boundary eliminating process can be performed after insertion of a clock buffer, like in the second embodiment. When the risk-boundary eliminating process is performed after insertion of a clock buffer, the placement area can be reduced more than in the second embodiment.

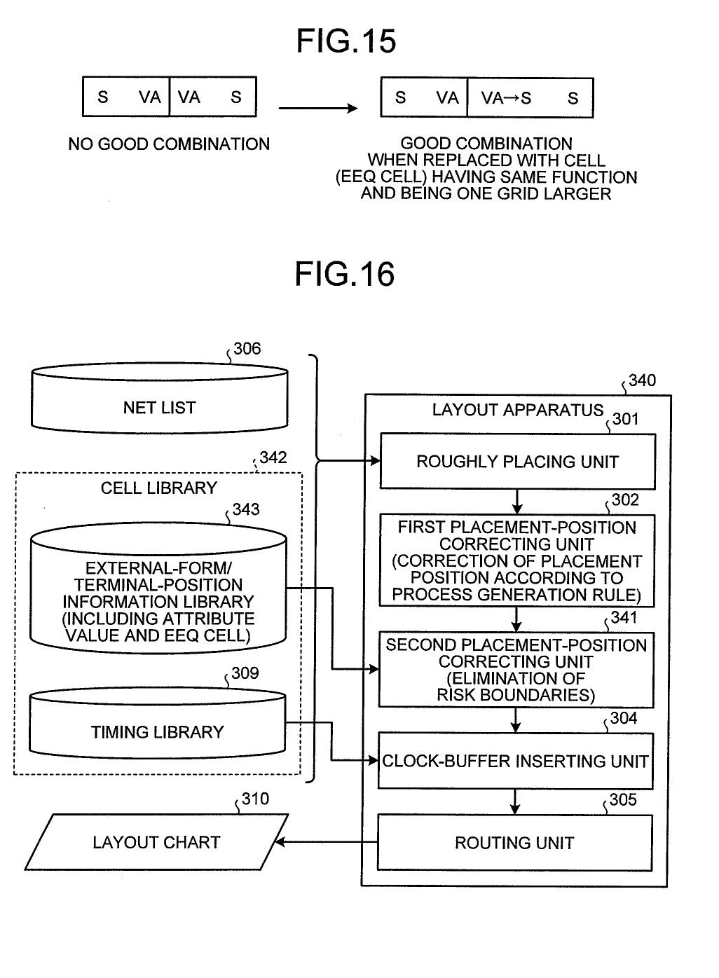

In a fourth embodiment of the present invention, cell layout data electrically equivalent to cells assigned with attributes A, V, or VA as the adjacent placement risk attributes and having edges assigned with one of the three attributes of original cell layout data enlarged by one placement grid are prepared and stored in an external-form/terminal-position information library. A cell that is electrically equivalent and has an edge of original cell layout data assigned with one of the three attributes enlarged by one placement grid is referred to as “electrically equivalent cell (EEC)”. In a risk-boundary eliminating process, one of cells constituting a risk boundary (right-hand cell) is replaced with an EEQ cell having a bordering edge that is one grid larger than the original cell, to eliminate the risk boundary. FIG. 15 is a conceptual diagram of a risk-boundary eliminating process according to the fourth embodiment. As shown in FIG. 15, a right edge of a target cell having the right edge with the attribute VA and a left edge of a right-hand adjacent cell having the left edge with the attribute VA are adjacently placed and constitute a risk boundary. When the right-hand adjacent cell is replaced with an EEQ cell having a left edge one grid larger, the cell boundary comes to be no longer the risk boundary.

FIG. 16 is a configuration diagram of a layout apparatus according to the fourth embodiment. Constituent units having like functions as those in the first embodiment are denoted by like reference numerals as those in the first embodiment and detailed explanations thereof will be omitted. A layout apparatus 340 includes a second placement-position correcting unit 341 as a different constituent unit from that in the first embodiment. A cell library 342 including the timing library 309 and an external-form/terminal-position information library 343 having EEQ cells added thereto is inputted to the layout apparatus 340. The second placement-position correcting unit 341 performs the risk-boundary eliminating process according to the fourth embodiment for a layout corrected by the first placement-position correcting unit 302, thereby eliminating a risk boundary.

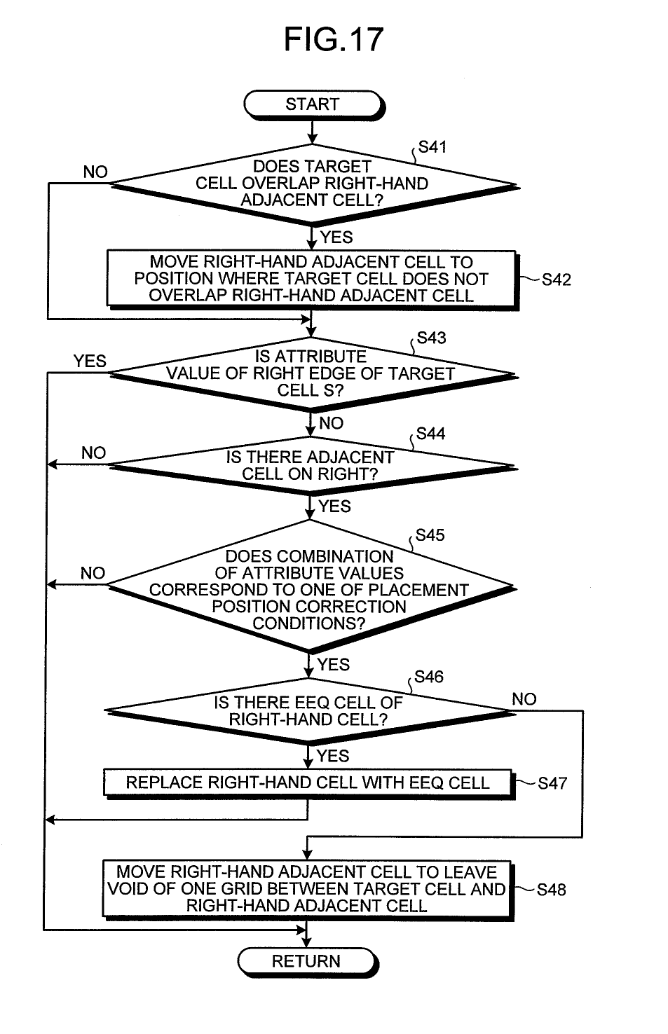

A layout method according to the fourth embodiment is explained. Only the risk-boundary eliminating process as a different part from the first embodiment is explained here. FIG. 17 is a flowchart of the risk-boundary eliminating process according to the fourth embodiment.

As shown in FIG. 17, at Steps S41 to S44, the second placement-position correcting unit 341 performs the same processes as those at Steps S11 to S14 performed by the second placement-position correcting unit 303. The second placement-position correcting unit 341 then determines whether a combination of an attribute value of a right edge of a target cell and an attribute value of a left edge of a right-hand adjacent cell meets the placement position correction conditions (S45). When the combination does not meet the placement position correction conditions (NO at Step S45), the risk-boundary eliminating process for the target cell is brought to RETURN.

When the combination meets the placement position correction conditions (YES at Step S45), the second placement-position correcting unit 341 searches the external-form/terminal-position information library 343 to determine whether there is an EEQ cell (S46). When there is an EEQ cell (YES at Step S46), the second placement-position correcting unit 341 replaces the right-hand adjacent cell with the EEQ cell (S47), and the risk-boundary eliminating process for the target cell is brought to RETURN. When there is no EEQ cell (NO at Step S46), the second placement-position correcting unit 341 moves the right-hand adjacent cell to the right by a distance corresponding to one grid (S48), and then the risk-boundary eliminating process for the target cell is brought to RETURN.

As described above, the cell library is adapted to include design data of electrically equivalent cells each corresponding to a cell having an edge associated with an attribute indicating the cell easily causes a defect in an adjacent cell or an attribute indicating an adjacent cell easily causes a defect in the cell, and having the edge elongated by a unit grid width of the placement grid. Accordingly, a risk boundary can be eliminated by a simple process of replacing one of cells constituting the risk boundary with an equivalent cell corresponding thereto. The cell can be replaced with a cell being electrically equivalent and having an attribute that does not produce a risk boundary.

In the above explanations, the risk-boundary eliminating process is performed before insertion of a clock buffer. The risk-boundary eliminating process can be performed after insertion of a clock buffer, like in the second embodiment.

The fourth and third embodiments can be combined. Specifically, the process at Step S46 can be performed after a result of the determination at Step S37 is YES, for example.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cell library for layout design of a semiconductor integrated circuit comprising:
a library of cell design data configured to implement a component function,
wherein each cell design data comprises attribute information comprising an attribute value associated with an edge of each cell indicating a likeliness that each cell will cause a defect in an adjacent cell across the edge and a likeliness that a defect will be caused by an adjacent cell across the edge.

2. The cell library of claim 1, wherein
the cell design data comprise outline and terminal position information describing an outline of a cell and a position of a terminal in the cell, and
the attribute information is in the outline and terminal position information of each cell.

3. The cell library of claim 1, wherein
the cell design data comprise timing information describing a signal transition time, and
the attribute information is in the timing information of each cell.

4. The cell library of claim 1, further comprising design data of electrically equivalent cells each corresponding to a cell comprising an edge associated with an attribute value indicating the likeliness that the cell will cause a defect in an adjacent cell or an attribute value indicating the likeliness that a defect will be caused by an adjacent cell, and comprising the edge elongated by a grid width of a placement grid.

5. A layout method for a semiconductor integrated circuit, comprising:
placing a plurality of cells based on a cell library comprising a library of cell design data configured to implement a component function, each cell design data comprising attribute information comprising an attribute value associated with an edge of each cell indicating a likeliness that each cell will cause a defect in an adjacent cell across the edge and a likeliness that a defect will be caused by an adjacent cell across the edge, and based on a net list of the semiconductor integrated circuit to be designed;
first correcting placement positions of the plurality of cells according to a rule based on a generation of a process; and
second correcting placement positions based on the attribute information when there is a boundary where a defect is caused at a cell boundary between adjacent cells after the first correcting, in order to eliminate the boundary.

6. The layout method of claim 5, further comprising placing a clock buffer before the second correcting.

7. The layout method of claim 5, wherein the second correcting is inserting of a gap with a predetermined width in the boundary between cells.

8. The layout method of claim 7, wherein a width of the gap is longer than a distance reached by an optical proximity effect.

9. The layout method of claim 7, wherein a width of the gap is substantially equal to a grid width of a placement grid.

10. The layout method of claim 5, wherein the second correcting is reversing one of cells on the boundary in order to change an edge of the cell bordering the cell boundary.

11. The layout method of claim 5, wherein
the cell library comprises cell design data of electrically equivalent cells each corresponding to a cell comprising an edge associated with an attribute value indicating the likeliness that the cell will cause a defect in an adjacent cell or an attribute value indicating the likeliness that a defect is easily caused by an adjacent cell, and comprising the edge elongated by a grid width of a placement grid, and
the second correcting comprises replacing one of cells on the risk boundary with an equivalent cell corresponding to the cell.

12. The layout method of claim 5, wherein
the cell design data comprises outline and terminal position information describing an outline of a cell and a position of a terminal in the cell, and
the second correcting is based on the attribute information in the outline and terminal position information of each cell.

13. The layout method of claim 5, wherein
the cell design data comprise timing information describing a signal transition time, and
the second correcting is based on the attribute information in the timing information of each cell.

14. A layout apparatus for a semiconductor integrated circuit, comprising:
a locating module configured to locate a plurality of cells based on a cell library comprising a library of cell design data configured to implement a component function, each cell design data comprising attribute information comprising an attribute value associated with an edge of each cell indicating a likeliness that each cell will cause a defect in an adjacent cell across the edge and a likeliness that a defect will be caused by an adjacent cell across the edge, and based on a net list of the semiconductor integrated circuit to be designed;
a first position correcting module configured to correct positions of the located cells according to a rule based on a generation of a process; and
a second position correcting module configured to correct positions based on the attribute information when there is a boundary where a defect is caused at a cell boundary between adjacent cells after correction by the first position correcting module, in order to eliminate the boundary.

15. The layout apparatus of claim 14, further comprising a clock-buffer inserting module configured to insert a clock buffer.

16. The layout apparatus of claim 14, wherein correction by the second position correcting module is insertion of a gap with a predetermined width between cells on the boundary.

17. The layout apparatus of claim 16, wherein a width of the gap is longer than a distance reached by an optical proximity effect.

18. The layout apparatus of claim 16, wherein a width of the gap is substantially equal to a grid width of a placement grid.

19. The layout apparatus of claim 14, wherein correction by the second position correcting module is reversal of one of cells on the boundary in order to change an edge of the cell bordering the cell boundary.

20. The layout apparatus of claim 14, wherein
the cell library comprises design data of electrically equivalent cells each corresponding to a cell comprising an edge associated with an attribute value indicating the likeliness that the cell will cause a defect in an adjacent cell or an attribute value indicating the likeliness that a defect will be caused by an adjacent cell, and comprising the edge elongated by a grid width of a placement grid, and
correction by the second position correcting module is replacement of one of cells on the boundary with an equivalent cell corresponding to the cell.
